(19) United States
(12) Patent Application Publication
(10) Pub. No.: US 2024/0302498 A1
(43) Pub. Date: Sep. 12, 2024

(54) Antireflective Coating for Automotive Applications

(71) Applicant: Vitro Flat Glass LLC, Cheswick, PA (US)

(72) Inventors: Paul A. Medwick, Wexford, PA (US); Andrew V. Wagner, Pittsburgh, PA (US); Benjamin Lucci, Carbondale, PA (US); Patrick Fisher, Pittsburgh, PA (US)

(21) Appl. No.: 18/593,298

(22) Filed: Mar. 1, 2024

Related U.S. Application Data
(60) Provisional application No. 63/450,693, filed on Mar. 8, 2023.

(51) Int. Cl. G01S 7/481; B32B 17/10; G01S 17/931; G02B 1/115

(52) U.S. Cl. CPC G01S 7/4811; B32B 17/10036; B32B 17/10201; B32B 17/10761; G01S 17/931; G02B 1/115

(57) ABSTRACT

A coated article includes: a substrate; a first dielectric layer including a metal oxide, metal alloy oxide, or a combination thereof and having a thickness of up to 40 nm over at least a portion of the substrate; a second dielectric layer having a thickness of up to 40 nm over at least a portion of the first dielectric layer; a third dielectric layer including a metal oxide, metal alloy oxide, or a combination thereof and having a thickness of at least 130 nm over at least a portion of the second dielectric layer; and a fourth dielectric layer having a thickness of at least 130 nm over at least a portion of the third dielectric layer; where the coated article, when contacted at 60° with light having a wavelength between 800 nm to 1,050 nm from a light source, transmits at least 75% of the light.

### CROSS-REFERENCE TO RELATED APPLICATION

This application claims the benefit of U.S. Provisional Patent Application No. 63/450,693, filed Mar. 8, 2023, the disclosure of which is hereby incorporated by reference in its entirety.

### BACKGROUND OF THE INVENTION

### Field of the Invention

This invention relates generally to antireflective coatings and articles coated with antireflective coatings.

### Technical Considerations

Substrates, such as windshields for vehicles, may require high transmittance of infrared radiation in order for sensors (e.g., Light Detecting and Ranging (LiDAR) sensors) located behind the substrate to accurately detect infrared radiation. However, existing substrates for application with LiDAR systems reflect some of the infrared radiation which reduces the amount of infrared radiation that is transmitted and that can be detected by the sensor, resulting in inaccurate readings. Therefore, there is a current need for improved substrates with increased antireflection of infrared radiation.

### SUMMARY OF THE INVENTION

In one aspect of the present invention, a coated article includes a substrate; a first dielectric layer including a metal oxide, metal alloy oxide, metal nitride, metal alloy nitride, or a combination thereof and having a thickness of up to 40 nm over at least a portion of the substrate; a second dielectric layer including a metal oxide, metal alloy oxide, metal nitride, metal alloy nitride or a combination thereof and having a thickness of up to 40 nm over at least a portion of the first dielectric layer; a third dielectric layer including a metal oxide, metal alloy oxide, metal nitride, metal alloy nitride, or a combination thereof and having a thickness of at least 130 nm over at least a portion of the second dielectric layer; and a fourth dielectric layer including a metal oxide, metal alloy oxide, metal nitride, metal alloy nitride, or a combination thereof and having a thickness of at least 130 nm over at least a portion of the third dielectric layer; where the coated article, when contacted at 60° with light having a wavelength between 800 nm to 1,050 nm from a light source, transmits at least 75% of the light.

In another aspect of the present invention, a LiDAR system includes: a windshield, including: a first ply including a first surface and a second surface opposite the first surface; a second ply including a third surface adjacent the second surface and a fourth surface opposite the third surface; a first dielectric layer including a metal oxide, metal alloy oxide, metal nitride, metal alloy nitride, or a combination thereof and having a thickness of up to 40 nm over at least a portion of the first surface or the fourth surface; a second dielectric layer having a thickness of up to 40 nm over at least a portion of the first dielectric layer; a third dielectric layer including a metal oxide, metal alloy oxide, metal nitride, metal alloy nitride, or a combination thereof and having a thickness of at least 130 nm over at least a portion of the second dielectric layer; and a fourth dielectric layer having a thickness of at least 130 nm over at least a portion of the third dielectric layer; where the windshield, when contacted at 60° with light having a wavelength between 800 nm to 1,050 nm from a light source, transmits at least 75% of the light, and at least one LiDAR sensor positioned proximate to the fourth surface.

In another aspect of the present invention, an autonomous vehicle includes: a LiDAR system, the LiDAR system including: a windshield, including: a first ply including a first surface and a second surface opposite the first surface; a second ply including a third surface adjacent the second surface and a fourth surface opposite the third surface; a first dielectric layer including a metal oxide, metal alloy oxide, metal nitride, metal alloy nitride, or a combination thereof and having a thickness of up to 40 nm over at least a portion of the first surface or the fourth surface; a second dielectric layer having a thickness of up to 40 nm over at least a portion of the first dielectric layer; a third dielectric layer including a metal oxide, metal alloy oxide, metal nitride, metal alloy nitride, or a combination thereof and having a thickness of at least 130 nm over at least a portion of the second dielectric layer; and a fourth dielectric layer having a thickness of at least 130 nm over at least a portion of the third dielectric layer; where the windshield, when contacted at 60° with light having a wavelength between 800 nm to 1,050 nm from a light source, transmits at least 75% of the light, and at least one LiDAR sensor positioned proximate to the fourth surface.

Various non-limiting examples and aspects of the present invention will now be described and set forth in the following numbered clauses:
Clause 1: A coated article, comprising: a substrate; a first dielectric layer comprising a metal oxide, metal alloy oxide, metal nitride, metal alloy nitride, or a combination thereof and having a thickness of up to 40 nm over at least a portion of the substrate; a second dielectric layer having a thickness of up to 40 nm over at least a portion of the first dielectric layer; a third dielectric layer comprising a metal oxide, metal alloy oxide, metal nitride, metal alloy nitride, or a combination thereof and having a thickness of at least 130 nm over at least a portion of the second dielectric layer; and a fourth dielectric layer having a thickness of at least 130 nm over at least a portion of the third dielectric layer; wherein the coated article, when contacted at 60° with light having a wavelength between 800 nm to 1,050 nm from a light source, transmits at least 75% of the light.
Clause 2: The coated article of clause 1, wherein the substrate comprises glass having a total iron content of at most 0.02 wt %.
Clause 3: The coated article of clause 1 or clause 2, wherein the first dielectric layer and the third dielectric layer comprise the same material.
Clause 4: The coated article of any of clauses 1-3, wherein the first dielectric layer and the third dielectric layer each independently comprise zinc stannate, zinc oxide, tin oxide, silicon nitride, or a combination thereof.
Clause 5: The coated article of any of clauses 1-4, wherein the second dielectric layer and the fourth dielectric layer comprise the same material.
Clause 6: The coated article of any of clauses 1-5, wherein the second dielectric layer and the fourth dielectric layer each independently comprise silicon, silicon and aluminum, alloys comprising silicon, or a combination thereof.
Clause 7: The coated article of any of clauses 1-6, wherein the second dielectric layer and the fourth dielectric layer each independently comprise an oxide, a nitride, an oxynitride, or a combination thereof.
Clause 8: The coated article of any of clauses 1-7, wherein the second dielectric layer and the fourth dielectric layer each independently comprise silicon oxide, silicon aluminum oxide, or a combination thereof.
Clause 9: The coated article of any of clauses 1-8, wherein the first dielectric layer and the second dielectric layer have a thickness in a range of from 10 nm to 40 nm.
Clause 10: The coated article of any of clauses 1-9, wherein the first dielectric layer and the second dielectric layer have a thickness in a range of from 20 nm to 35 nm.
Clause 11: The coated article of any of clauses 1-10, wherein the third dielectric layer and the fourth dielectric layer have a thickness in a range of from 130 nm to 180 nm.
Clause 12: The coated article of any of clauses 1-11, wherein the third dielectric layer has a thickness in a range of from 145 nm to 170 nm, and the fourth dielectric layer has a thickness in a range of from 135 nm to 180 nm.
Clause 13: The coated article of any of clauses 1-12, wherein the first dielectric layer and the second dielectric layer are in direct contact with one another, and wherein the third dielectric layer and the fourth dielectric layer are in direct contact with one another.
Clause 14: The coated article of any of clauses 1-13, wherein the second dielectric layer and the third dielectric layer are in direct contact with one another.
Clause 15: The coated article of any of clauses 1-14, wherein the light has a wavelength of about 900 nm.
Clause 16: The coated article of any of clauses 1-15, wherein the coated article transmits at least 80% of the light.
Clause 17: The coated article of any of clauses 1-16, wherein the coated article transmits at least 85% of the light.
Clause 18: The coated article of any of clauses 1-17, wherein the coated article consists of: the substrate; the first dielectric layer; the second dielectric layer; the third dielectric layer; and the fourth dielectric layer.
Clause 19: A LiDAR system, comprising: a windshield, comprising: a first ply comprising a first surface and a second surface opposite the first surface; a second ply comprising a third surface adjacent the second surface and a fourth surface opposite the third surface; a first dielectric layer comprising a metal oxide, metal alloy oxide, metal nitride, metal alloy nitride, or a combination thereof and having a thickness of up to 40 nm over at least a portion of the first surface or the fourth surface; a second dielectric layer having a thickness of up to 40 nm over at least a portion of the first dielectric layer; a third dielectric layer comprising a metal oxide, metal alloy oxide, metal nitride, metal alloy nitride, or a combination thereof and having a thickness of at least 130 nm over at least a portion of the second dielectric layer; and a fourth dielectric layer having a thickness of at least 130 nm over at least a portion of the third dielectric layer; wherein the windshield, when contacted at 60° with light having a wavelength between 800 nm to 1,050 nm from a light source, transmits at least 75% of the light, and at least one LiDAR sensor positioned proximate to the fourth surface.
Clause 20: The LiDAR system of clause 19, wherein the first ply and/or the second ply comprise glass having a total iron content of at most 0.02 wt %.
Clause 21: The LiDAR system of clause 19 or clause 20, wherein the first dielectric layer and the third dielectric layer comprise the same material.
Clause 22: The LiDAR system of any of clauses 19-21, wherein the first dielectric layer and the third dielectric layer each independently comprise zinc stannate, zinc oxide, tin oxide, silicon nitride, or a combination thereof.
Clause 23: The LiDAR system of any of clauses 19-22, wherein the second dielectric layer and the fourth dielectric layer comprise the same material.
Clause 24: The LiDAR system of any of clauses 19-23, wherein the second dielectric layer and the fourth dielectric layer each independently comprise silicon, silicon and aluminum, alloys comprising silicon, or a combination thereof.
Clause 25: The LiDAR system of any of clauses 19-24, wherein the second dielectric layer and the fourth dielectric layer each independently comprise an oxide, a nitride, an oxynitride, or a combination thereof.
Clause 26: The LiDAR system of any of clauses 19-25, wherein the second dielectric layer and the fourth dielectric layer each independently comprise silicon oxide, silicon aluminum oxide, or a combination thereof.
Clause 27: The LiDAR system of any of clauses 19-26, wherein the first dielectric layer and the second dielectric layer have a thickness in a range of from 10 nm to 40 nm.
Clause 28: The LiDAR system of any of clauses 19-27, wherein the first dielectric layer and the second dielectric layer have a thickness in a range of from 20 nm to 35 nm.
Clause 29: The LiDAR system of any of clauses 19-28, wherein the third dielectric layer and the fourth dielectric layer have a thickness in a range of from 130 nm to 180 nm.
Clause 30: The LiDAR system of any of clauses 19-29, wherein the third dielectric layer has a thickness in a range of from 145 nm to 170 nm, and the fourth dielectric layer has a thickness in a range of from 135 nm to 180 nm.
Clause 31: The LiDAR system of any of clauses 19-30, wherein the first dielectric layer and the second dielectric layer are in direct contact with one another, and wherein the third dielectric layer and the fourth dielectric layer are in direct contact with one another.
Clause 32: The LiDAR system of any of clauses 19-31, wherein the second dielectric layer and the third dielectric layer are in direct contact with one another.
Clause 33: The LiDAR system of any of clauses 19-32, wherein the light has a wavelength of about 900 nm.
Clause 34: The LiDAR system of any of clauses 19-33, wherein the windshield transmits at least 80% of the light.
Clause 35: The LiDAR system of any of clauses 19-34, wherein the windshield transmits at least 85% of the light.
Clause 36: The LiDAR system of any of clauses 19-35, wherein the windshield consists of: the first ply; the second ply the first dielectric layer; the second dielectric layer; the third dielectric layer; and the fourth dielectric layer.
Clause 37: An autonomous vehicle, comprising: a LiDAR system, the LiDAR system comprising: a windshield, comprising: a first ply comprising a first surface and a second surface opposite the first surface; a second ply comprising a third surface adjacent the second surface and a fourth surface opposite the third surface; a first dielectric layer comprising a metal oxide, metal alloy oxide, or a combination thereof and having a thickness of up to 40 nm over at least a portion of the first surface or the fourth surface; a second dielectric layer having a thickness of up to 40 nm over at least a portion of the first dielectric layer; a third dielectric layer comprising a metal oxide, metal alloy oxide, or a combination thereof and having a thickness of at least 130 nm over at least a portion of the second dielectric layer; and a fourth dielectric layer having a thickness of at least 130 nm over at least a portion of the third dielectric layer; wherein the windshield, when contacted at 60° with light having a wavelength between 800 nm to 1,050 nm from a light source, transmits at least 75% of the light, and at least one LiDAR sensor positioned proximate to the fourth surface.
Clause 38: The autonomous vehicle of clause 37, wherein the first ply and/or the second ply comprise glass having a total iron content of at most 0.02 wt %.
Clause 39: The autonomous vehicle of clause 37 or clause 38, wherein the first dielectric layer and the third dielectric layer comprise the same material.
Clause 40: The autonomous vehicle of any of clauses 37-39, wherein the first dielectric layer and the third dielectric layer each independently comprise zinc stannate, zinc oxide, tin oxide, silicon nitride, or a combination thereof.
Clause 41: The autonomous vehicle of any of clauses 37-40, wherein the second dielectric layer and the fourth dielectric layer comprise the same material.
Clause 42: The autonomous vehicle of any of clauses 37-41, wherein the second dielectric layer and the fourth dielectric layer each independently comprise silicon, silicon and aluminum, alloys comprising silicon, or a combination thereof.
Clause 43: The autonomous vehicle of any of clauses 37-42, wherein the second dielectric layer and the fourth dielectric layer each independently comprise an oxide, a nitride, an oxynitride, or a combination thereof.
Clause 44: The autonomous vehicle of any of clauses 37-43, wherein the second dielectric layer and the fourth dielectric layer each independently comprise silicon oxide, silicon aluminum oxide, or a combination thereof.
Clause 45: The autonomous vehicle of any of clauses 37-44, wherein the first dielectric layer and the second dielectric layer have a thickness in a range of from 10 nm to 40 nm.
Clause 46: The autonomous vehicle of any of clauses 37-45, wherein the first dielectric layer and the second dielectric layer have a thickness in a range of from 20 nm to 35 nm.
Clause 47: The autonomous vehicle of any of clauses 37-46, wherein the third dielectric layer and the fourth dielectric layer have a thickness in a range of from 130 nm to 180 nm.
Clause 48: The autonomous vehicle of any of clauses 37-47, wherein the third dielectric layer has a thickness in a range of from 145 nm to 170 nm, and the fourth dielectric layer has a thickness in a range of from 135 nm to 180 nm.
Clause 49: The autonomous vehicle of any of clauses 37-48, wherein the first dielectric layer and the second dielectric layer are in direct contact with one another, and wherein the third dielectric layer and the fourth dielectric layer are in direct contact with one another.
Clause 50: The autonomous vehicle of any of clauses 37-49, wherein the second dielectric layer and the third dielectric layer are in direct contact with one another.
Clause 51: The autonomous vehicle of any of clauses 37-50, wherein the light has a wavelength of about 900 nm.
Clause 52: The autonomous vehicle of any of clauses 37-51, wherein the windshield transmits at least 80% of the light.
Clause 53: The autonomous vehicle of any of clauses 37-52, wherein the windshield transmits at least 85% of the light.
Clause 54: The autonomous vehicle of any of clauses 37-53, wherein the windshield consists of: the first ply; the second ply; the first dielectric layer; the second dielectric layer; the third dielectric layer; and the fourth dielectric layer.

### BRIEF DESCRIPTION OF THE DRAWINGS

The invention will be described with reference to the following drawing figures wherein like reference numbers identify like parts throughout.

FIG. 1 is a cross-sectional view (not to scale) of a coated article according to one aspect of the present invention;

FIG. 2 is a cross-sectional view (not to scale) of a monolithic transparency according to another aspect of the present invention;

FIG. 3 is a cross-sectional view (not to scale) windshield according to another aspect of the present invention;

FIG. 4 is a schematic view of the coated article of FIG. 1, monolithic transparency of FIG. 2, or windshield of FIG. 3 and a light source according to another aspect of the present invention;

FIG. 5 is a schematic view of a LiDAR system according to another aspect of the present invention;

FIG. 6 is a graph of the spectral transmittance of a monolithic antireflective-coated substrate and a monolithic non-coated substrate at an angle of incidence of 0°; and

FIG. 7 is a graph of the spectral transmittance of a monolithic antireflective-coated substrate and a monolithic non-coated substrate at an angle of incidence of 0°.

### DESCRIPTION OF THE PREFERRED EMBODIMENTS

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. The terms “visible region”, “visible light”, or “visible light spectrum” refer to electromagnetic radiation having a wavelength in the range of 380 nm to 800 nm. The terms “infrared region”, “infrared radiation”, or “infrared spectrum” refer to electromagnetic radiation having a wavelength in the range of greater than 800 nm to 100,000 nm. The terms “ultraviolet region”, “ultraviolet radiation”, or “ultraviolet (UV) spectrum” mean electromagnetic energy having a wavelength in the range of 300 nm to less than 380 nm. Additionally, all documents, such as, but not limited to, issued patents and patent applications, referred to herein are to be considered to be “incorporated by reference” in their entirety.

A “layer” can comprise one or more “films”, and a “coating” or “coating stack” can comprise one or more “layers”. The term “includes” is synonymous with “comprises”.

The discussion of the invention may describe certain features as being “particularly” or “preferably” within certain limitations (e.g. “preferably”, “more preferably”, or “most preferably”, within certain limitations). It is to be understood that the invention is not limited to these particular or preferred limitations but encompasses the entire scope of the disclosure.

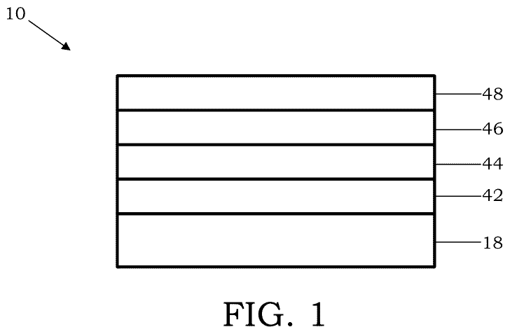

As shown in FIG. 1, a coated article 10 is provided. In some non-limiting embodiments, the coated article 10 includes a substrate 18; a first dielectric layer 42 over at least a portion of the substrate 18; a second dielectric layer 44 over at least a portion of the first dielectric layer 42; a third dielectric layer 46 over at least a portion of the second dielectric layer 44; and a fourth dielectric layer 48 over at least a portion of the third dielectric layer 46. In some non-limiting embodiments, the coated article 10, when contacted at 60° with light having a wavelength between 800 nm to 1,050 nm from a light source, transmits at least 75% of the light.

In the broad practice of the invention, the substrate 18 can include glass. For example, the substrate 18 can include conventional soda-lime-silicate glass, borosilicate glass, or leaded glass. The glass can be clear glass. By “clear glass” is meant non-tinted or non-colored glass. The glass can be annealed or heat-treated glass. As used herein, the term “heat-treated” means tempered or at least partially tempered. The glass can be conventional float glass. By “float glass” is meant glass formed by a conventional float process in which molten glass is deposited onto a molten metal bath and controllably cooled to form a float glass ribbon. The ribbon is then cut and/or shaped and/or heat treated as desired. Examples of float glass processes are disclosed in U.S. Pat. Nos. 4,466,562 and 4,671,155. Although not limiting to the invention, examples of glass suitable for the substrate 18 is described in U.S. Patent Application Publication No. 2014/0309099, the disclosure of which is hereby incorporated by reference in its entirety. The substrate 18 can be of any desired dimensions, e.g., length, width, shape, or thickness. In some non-limiting embodiments, the substrate 18 can each be 1 mm to 10 mm thick, e.g., 1 mm to 5 mm thick, or 1.5 mm to 2.5 mm, or 1.8 mm to 2.3 mm. In some non-limiting embodiments, the substrate 18 can have a visible light transmittance of greater than 90%, such as greater than 91%, at a reference wavelength of 550 nm. The glass composition for the substrate 18 can have a total iron content (as Fe₂O₃) of greater than zero weight percent (wt %). The glass composition for the substrate 18 can have a total iron content of up to 0.02 wt %, or up to 0.01 wt %. The glass composition for the substrate 18 can have a total iron content in the range of greater than 0 wt % to 0.02 wt %, or greater than 0 wt % to 0.01 wt %. The glass composition for the substrate 18 can have tin and/or tin containing compounds providing tin in an amount within the range of greater than 0.005 wt % to 5.0 wt %. A glass formed from a glass composition having the previously mentioned properties may be referred to as “ultra-clear” glass.

In some non-limiting embodiments, the coated article 10 includes a first dielectric layer 42 over at least a portion of the substrate 18. The first dielectric layer 42 may include a metal oxide, a metal alloy oxide, metal nitride, metal alloy nitride, or a combination thereof. Non-limiting examples of materials that may be used for the first dielectric layer 42 include a zinc/tin alloy oxide, zinc oxide, tin oxide, silicon nitride, or a combination thereof. For example, the first dielectric layer 42 may comprise tin oxide, a zinc/tin alloy oxide or zinc stannate.

In some non-limiting embodiments, the first dielectric layer 42 can be a metal oxide, such as tin oxide. The tin oxide can be deposited in an oxygen (O₂) environment from a tin target or from a tin target that includes other materials to improve the sputtering characteristics of the target. For example, the O₂ flow rate (i.e., concentration of O₂ in the atmosphere for the chamber where the material is being deposited) can be up to 80% O₂, such as, 80% O₂, 75% O₂, or 70% O₂. The remainder of the atmosphere can be an inert gas, such as, argon. The tin oxide can be obtained from magnetron sputtering vacuum deposition from a target of tin or a target of tin and zinc. For example, the tin target can include a small amount (e.g., up to 20 wt %, up to 15 wt %, up to 10 wt %, or up to 5 wt %) of zinc. In which case, the resultant tin oxide film would include a small percentage of zinc oxide, e.g., up to 20 wt % zinc oxide, e.g., up to 10 wt % zinc oxide, e.g., up to 5 wt % zinc oxide. A coating layer deposited from a tin target with 0 to 20 wt % zinc is referred to as a “tin oxide” layer. The first dielectric layer 42 may comprise tin oxide where tin is substantially the only metal in the first dielectric layer 42. As used herein, “substantially free” means that the tin oxide contains less than 0.5 wt % of additional metals other than tin. The first dielectric layer 42 may include 80 wt % tin oxide and 20 wt % zinc oxide. The first dielectric layer 42 may include 90 wt % tin oxide and 10 wt % zinc oxide.

In some non-limiting embodiments, the first dielectric layer 42 may include a zinc/tin alloy oxide. The zinc/tin alloy oxide can be obtained from MSVD from a cathode of zinc and tin that can comprise zinc and tin in proportions of 10 wt % to 90 wt % zinc and 90 wt % to 10 wt % tin. One suitable metal alloy oxide that can be present in the first film of the first dielectric layer 42 is zinc stannate. By “zinc stannate” is meant a composition of ZnₓSn₁₋ₓO₂₋ₓ (Formula 1) where “x” varies in the range of greater than 0 to less than 1. For instance, “x” can be greater than 0 and can be any fraction or decimal between greater than 0 to less than 1. For example, where x=⅔, Formula 1 is Zn_{2/3}Sn_{1/3}O_{4/3}, which is more commonly described at Zn₂SnO₄. A zinc stannate containing layer or film has one or more of the forms of Formula 1 in a predominant amount in the layer or film.

In some non-limiting embodiments, the first dielectric layer 42 may include zinc oxide. The zinc oxide can be deposited from a zinc cathode that includes other materials to improve the sputtering characteristics of the cathode. For example, the zinc cathode can include a small amount (e.g., less than 10 wt %, such as greater than 0 to 5 wt %) of tin to improve sputtering. In which case, the resultant zinc oxide film would include a small percentage of tin oxide, e.g., 0 to less than 10 wt % tin oxide, e.g., 0 to 5 wt % tin oxide. An oxide layer sputtered from a zinc/tin cathode having 95 wt % zinc and 5 wt % tin, or preferably 90 wt % zinc and 10 wt % tin, is referred to as a layer including zinc oxide. The small amount of tin in the cathode (e.g., less than 10 wt %) is believed to form a small amount of tin oxide in the predominately zinc oxide-containing first dielectric layer 42.

The first dielectric layer 42 may have a thickness of at least 1 nm, or at least 3 nm, or at least 5 nm, or at least 8 nm, or at least 10 nm, or at least 20 nm. The first dielectric layer 42 may have a thickness of up to 70 nm, or up to 60 nm, or up to 50 nm, or up to 40 nm, or up to 35 nm. The first dielectric layer 42 may have a thickness in the range of from 1 nm to 70 nm, or from 3 nm to 60 nm, or from 8 nm to 50 nm, or from 10 nm to 40 nm, or from 20 nm to 35 nm.

The first dielectric layer 42 may have a refractive index that is higher than a refractive index of the second dielectric layer 44 and the fourth dielectric layer 48. The first dielectric layer 42 may have a refractive index that is the same as a refractive index of the third dielectric layer 46. In some non-limiting embodiments, the first dielectric layer 42 may have a refractive index of greater than 1.75, for example greater than 1.9, for example greater than 2.0 for light having a wavelength of 900 nm. For example, the first dielectric layer 42 may have a refractive index between 1.9 and 2.1, for example about 2.0, for light having a wavelength of 900 nm.

In some non-limiting embodiments, the coated article 10 includes a second dielectric layer 44 over at least a portion of the first dielectric layer 42. The second dielectric layer 44 may be in direct contact with the first dielectric layer 42. In some non-limiting embodiments, the second dielectric layer 44 may comprise silicon. For example, the second dielectric layer 44 may include silicon, silicon and aluminum, alloys comprising silicon, or a combination thereof. For example, the second dielectric layer 44 may include silicon oxide, silicon aluminum oxide, or a combination thereof. For example, the second dielectric layer 44 may comprise silicon oxide or silicon aluminum oxide. In another example, the second dielectric layer 44 may comprise silicon aluminum oxide

The second dielectric layer 44 may have a thickness of at least 1 nm, or at least 3 nm, or at least 5 nm, or at least 8 nm, or at least 10 nm, or at least 20 nm. The second dielectric layer 44 may have a thickness of up to 70 nm, or up to 60 nm, or up to 50 nm, or up to 40 nm, or up to 35 nm. The second dielectric layer 44 may have a thickness in the range of from 1 nm to 70 nm, or from 3 nm to 60 nm, or from 8 nm to 50 nm, or from 10 nm to 40 nm, or from 20 nm to 35 nm.

The second dielectric layer 44 may have a refractive index that is lower than a refractive index of the first dielectric layer 42 and the third dielectric layer 46. The second dielectric layer 44 may have a refractive index that is the same as a refractive index of the fourth dielectric layer 48. In some non-limiting embodiments, the second dielectric layer 44 may have a refractive index of less than 1.75, for example less than 1.7, for example less than 1.6 for light with a wavelength of 900 nm. For example, the second dielectric layer 44 may have a refractive index between 1.4 and 1.6, for example about 1.5, for light with a wavelength of 900 nm.

In some non-limiting embodiments, the coated article 10 includes a third dielectric layer 46 over at least a portion of the second dielectric layer 44. The third dielectric layer 46 may be in direct contact with the second dielectric layer 44. The third dielectric layer 46 may include the same or different material as the first dielectric layer 42. The third dielectric layer 46 may include a metal oxide, a metal alloy oxide, a metal nitride, a metal alloy nitride, or a combination thereof. Non-limiting examples of materials that may be used for the third dielectric layer 46 include a zinc/tin alloy oxide (e.g., zinc stannate), zinc oxide, tin oxide, silicon nitride, or a combination thereof. For example, the third dielectric layer 46 may be a zinc/tin alloy oxide or zinc stannate.

The third dielectric layer 46 may have a thickness of at least 100 nm, or at least 110 nm, or at least 120 nm, or at least 130 nm, or at least 140 nm, or at least 145 nm. The third dielectric layer 46 may have a thickness of up to 200 nm, or up to 190 nm, or up to 185 nm, or up to 180 nm, or up to 175 nm, or up to 170 nm. The third dielectric layer 46 may have a thickness in the range of 100 nm to 200 nm, or in the range of 110 nm to 190 nm, or in the range of 120 nm to 185 nm, or in the range of 130 nm to 180 nm, or in the range of 140 nm to 175 nm, or in the range of 145 nm to 170 nm.

The third dielectric layer 46 may have a refractive index that is higher than a refractive index of the second dielectric layer 44 and the fourth dielectric layer 48. The third dielectric layer 46 may have a refractive index that is the same as a refractive index of the first dielectric layer 42. In some non-limiting embodiments, the third dielectric layer 46 may have a refractive index of greater than 1.75, for example greater than 1.9, for example greater than 2.0 for light with a wavelength of 900 nm. For example, the third dielectric layer 46 may have a refractive index of about 2.0 for light with a wavelength of 900 nm.

In some non-limiting embodiments, the coated article 10 includes a fourth dielectric layer 48 over at least a portion of the third dielectric layer 46. The fourth dielectric layer 48 may be in direct contact with the third dielectric layer 46. The fourth dielectric layer 48 may include the same or different material as the second dielectric layer 44. In some non-limiting embodiments, the fourth dielectric layer 48 may comprise silicon. For example, the fourth dielectric layer 48 may include silicon, silicon and aluminum, alloys comprising silicon, or a combination thereof. For example, the fourth dielectric layer 48 may include silicon oxide, silicon aluminum oxide, or a combination thereof. For example, the fourth dielectric layer 48 may comprise silicon oxide or silicon aluminum oxide.

The fourth dielectric layer 48 may have a thickness of at least 100 nm, or at least 110 nm, or at least 120 nm, or at least 130 nm, or at least 135 nm. The fourth dielectric layer 48 may have a thickness of up to 200 nm, or up to 195 nm, or up to 190 nm, or up to 185 nm, or up to 180 nm. The fourth dielectric layer 48 may have a thickness in the range of 100 nm to 200 nm, or in the range of 110 nm to 195 nm, or in the range of 120 nm to 190 nm, or in the range of 130 nm to 185 nm, or in the range of 130 nm to 180 nm, or in the range of 135 nm to 180 nm.

The fourth dielectric layer 48 may have a refractive index that is lower than a refractive index of the first dielectric layer 42 and the third dielectric layer 46. The fourth dielectric layer 48 may have a refractive index that is the same as a refractive index of the second dielectric layer 44. In some non-limiting embodiments, the fourth dielectric layer 48 may have a refractive index of less than 1.75, for example less than 1.7, for example less than 1.6 for light with a wavelength of 900 nm. For example, the fourth dielectric layer 48 may have a refractive index between 1.4 and 1.6, for example about 1.5, for light with a wavelength of 900 nm.

The dielectric layers 42, 44, 46, 48 can be deposited by any conventional method, such as but not limited to conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as but not limited to sol-gel deposition. In one non-limiting embodiment, the dielectric layers 42, 44, 46, 48 can be deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750. In the MSVD method, an oxide of a metal or metal alloy can be deposited by sputtering a metal or metal alloy containing cathode in an oxygen containing atmosphere to deposit a metal oxide or metal alloy oxide film on the surface of the substrate.

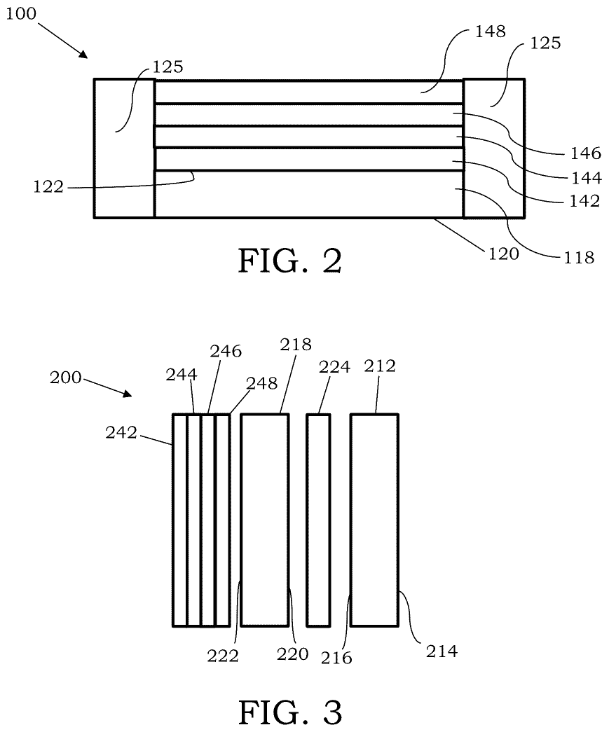

In some non-limiting embodiments, the coated article 10 described above can be incorporated into a monolithic glazing. The term “monolithic” refers to having a single structural support or structural member, e.g., having a single substrate. For example, as shown in FIG. 2, the coated article 10 described above can be incorporated into a conventional monolithic transparency 100, such as for a vehicle. For clarity, certain features of such a monolithic transparency, such as seals, connectors, and opening mechanisms are not shown, nor is a complete vehicle. The monolithic transparency 100 includes the coated article 10, where the substrate 18 is a first ply (substrate) 118 with a first major surface 122 (No. 1 surface) and a second major surface 120 (No. 2 surface) mounted in the body of a vehicle 125 (shown in part). The first ply 118 may be the same as the substrate 18 previously described. In some non-limiting embodiments, the first major surface 122 faces the interior of the vehicle, and thus is an inner major surface, and the second major surface 120 faces the exterior of the vehicle, and thus is an outer major surface. In some non-limiting embodiments, the first major surface 122 faces the exterior of the vehicle, and thus is an outer major surface, and the second major surface 120 faces the interior of the vehicle, and thus is an inner major surface. In some non-limiting embodiments, the vehicle body 125 may include an automobile door or frame in the case of an automobile window.

A first dielectric layer 142 may be positioned over at least a portion of the first major surface 122 of the first ply 118. The first dielectric layer 142 may be the same as the first dielectric layer 42 previously described. A second dielectric layer 144 may be positioned over at least a portion of the first dielectric layer 142. The second dielectric layer 144 may be the same as the second dielectric layer 44 previously described. A third dielectric layer 146 may be positioned over at least a portion of the second dielectric layer 144. The third dielectric layer 146 may be the same as the third dielectric layer 46 previously described. A fourth dielectric layer 148 may be positioned over at least a portion of the third dielectric layer 146. The fourth dielectric layer 148 may be the same as the fourth dielectric layer 48 previously described.

In some non-limiting embodiments, the coated article 10 previously described can be incorporated into a windshield 200. A non-limiting example of a windshield 200 incorporating the coated article 10 is illustrated in FIG. 3.

The windshield 200 can have a visible light transmission of greater than 70%. For windshield and front sidelight areas in the United States, the visible light transmission is typically greater than or equal to 70%. For privacy areas, such as rear seat sidelights and rear windows, the visible light transmission can be less than that for windshields, such as less than 70%.

As seen in FIG. 3, the windshield 200 includes a first ply or first substrate 212 with a first major surface facing the vehicle exterior, i.e. an outer major surface 214 (No. 1 surface) and an opposed second or inner major surface 216 (No. 2 surface). The windshield 200 also includes a second ply or second substrate 218 having an outer (first) major surface 222 (No. 4 surface) and an inner (second) major surface 220 (No. 3 surface). This numbering of the ply surfaces is in keeping with conventional practice in the automotive art. The first and second plies 212, 218 can be bonded together in any suitable manner, such as by conventional interlayer 224. Although not required, a conventional edge sealant can be applied to the perimeter of the windshield 200 during and/or after lamination in any desired manner.

The plies 212, 218 of the windshield 200 can comprise glass. The plies 212, 218 of the windshield 200 can comprise the same glass as the previously described glass for the substrate 18.

In one non-limiting embodiment, one or both of the plies 212, 218 may have a high visible light transmittance at a reference wavelength of 550 nm. By “high visible light transmittance” is meant visible light transmittance at 550 nm greater than or equal to 85%, such as greater than or equal to 87%, such as greater than or equal to 90%, such as greater than or equal to 91%, such as greater than or equal to 92%, at 5.5 mm equivalent thickness for glass from 2 mm to 25 mm sheet thickness. Particularly useful glass for the practice of the invention is disclosed in U.S. Pat. Nos. 5,030,593 and 5,030,594.

The interlayer 224 can be of any desired material and can include one or more layers or plies. The interlayer 224 can be a polymeric or plastic material, such as, for example, polyvinylbutyral (PVB), plasticized polyvinyl chloride, or multi-layered thermoplastic materials including polyethyleneterephthalate, etc. Suitable interlayer materials are disclosed, for example but not to be considered as limiting, in U.S. Pat. Nos. 4,287,107 and 3,762,988. The interlayer 224 can also be a sound absorbing or attenuating material as described, for example, in U.S. Pat. No. 5,796,055. The interlayer 224 can have a solar control coating provided thereon or incorporated therein or can include a colored material to reduce solar energy transmission.

In some non-limiting embodiments, a first dielectric layer 242 may be over at least a portion of a major surface of one of the glass plies 212, 218, such as on the outer surface 214 of the outboard glass ply 212 or the outer surface 222 of the interior glass ply 218. The first dielectric layer 242 may be the same as the first dielectric layer 42 previously described. The first dielectric layer 242 may include a metal oxide, a metal alloy oxide, metal nitride, metal alloy nitride, or a combination thereof. Non-limiting examples of materials that may be used for the first dielectric layer 242 include a zinc/tin alloy oxide, zinc oxide, tin oxide, silicon nitride, or a combination thereof. For example, the first dielectric layer 242 can comprise tin oxide, a zinc/tin alloy or zinc stannate.

In some non-limiting embodiments, the first dielectric layer 242 may include tin oxide, as previously described.

In some non-limiting embodiments, the first dielectric layer 242 may include a zinc/tin alloy oxide. The zinc/tin alloy oxide can be obtained from MSVD from a cathode of zinc and tin that can comprise zinc and tin in proportions of 10 wt % to 90 wt % zinc and 90 wt % to 10 wt % tin. One suitable metal alloy oxide that can be present in the first film of the first dielectric layer 242 is zinc stannate.

In some non-limiting embodiments, the first dielectric layer 242 may include zinc oxide, as previously described.

The first dielectric layer 242 may have a thickness of at least 1 nm, or at least 3 nm, or at least 5 nm, or at least 8 nm, or at least 10 nm, or at least 20 nm. The first dielectric layer 242 may have a thickness of up to 70 nm, or up to 60 nm, or up to 50 nm, or up to 40 nm, or up to 35 nm. The first dielectric layer 242 may have a thickness in the range of from 1 nm to 70 nm, or from 3 nm to 60 nm, or from 8 nm to 50 nm, or from 10 nm to 40 nm, or from 20 nm to 35 nm.

The first dielectric layer 242 may have a refractive index that is higher than a refractive index of the second dielectric layer 244 and the fourth dielectric layer 248. The first dielectric layer 242 may have a refractive index that is the same as a refractive index of the third dielectric layer 246. In some non-limiting embodiments, the first dielectric layer 242 may have a refractive index of greater than 1.75, for light having a wavelength of 900 nm. For example, the first dielectric layer 242 may have a refractive index of about 2.0, for light having a wavelength of 900 nm.

In some non-limiting embodiments, a second dielectric layer 244 may be positioned over at least a portion of the first dielectric layer 242. The second dielectric layer 244 may be in direct contact with the first dielectric layer 242. The second dielectric layer 244 may be the same as the second dielectric layer 44 previously described. In some non-limiting embodiments, the second dielectric layer 244 may comprise silicon. For example, the second dielectric layer 244 may include silicon, silicon and aluminum, alloys comprising silicon, or a combination thereof. For example, the second dielectric layer 244 may include silicon oxide, silicon aluminum oxide, or a combination thereof.

The second dielectric layer 244 may have a thickness of at least 1 nm, or at least 3 nm, or at least 5 nm, or at least 8 nm, or at least 10 nm, or at least 20 nm. The second dielectric layer 244 may have a thickness of up to 70 nm, or up to 60 nm, or up to 50 nm, or up to 40 nm, or up to 35 nm. The second dielectric layer 244 may have a thickness in the range of from 1 nm to 70 nm, or from 3 nm to 60 nm, or from 8 nm to 50 nm, or from 10 nm to 40 nm, or from 20 nm to 35 nm.

The second dielectric layer 244 may have a refractive index that is lower than a refractive index of the first dielectric layer 242 and the third dielectric layer 246. The second dielectric layer 244 may have a refractive index that is the same as a refractive index of the fourth dielectric layer 248. In some non-limiting embodiments, the second dielectric layer 244 may have a refractive index of less than 1.75, for example less than 1.7, for example less than 1.6 for light with a wavelength of 900 nm. For example, the second dielectric layer 244 may have a refractive index of between 1.4 and 1.6, for example, about 1.5, for light with a wavelength of 900 nm.

In some non-limiting embodiments, a third dielectric layer 246 may be provided over at least a portion of the second dielectric layer 244. The third dielectric layer 246 may be in direct contact with the second dielectric layer 244. The third dielectric layer 246 may be the same as the third dielectric layer 46 previously described. The third dielectric layer 246 may include the same or different material as the first dielectric layer 242. The third dielectric layer 246 may include a metal oxide, a metal alloy oxide, metal nitride, metal alloy nitride or a combination thereof. Non-limiting examples of materials that may be used for the third dielectric layer 246 include a zinc/tin alloy oxide (e.g., zinc stannate), zinc oxide, tin oxide, silicon nitride, or a combination thereof.

The third dielectric layer 246 may have a thickness of at least 100 nm, or at least 110 nm, or at least 120 nm, or at least 130 nm, or at least 140 nm, or at least 145 nm. The third dielectric layer 246 may have a thickness of up to 200 nm, or up to 190 nm, or up to 185 nm, or up to 180 nm, or up to 175 nm, or up to 170 nm. The third dielectric layer 246 may have a thickness in the range of 100 nm to 200 nm, or in the range of 110 nm to 190 nm, or in the range of 120 nm to 185 nm, or in the range of 130 nm to 180 nm, or in the range of 140 nm to 175 nm, or in the range of 145 nm to 170 nm.

The third dielectric layer 246 may have a refractive index that is higher than a refractive index of the second dielectric layer 244 and the fourth dielectric layer 248. The third dielectric layer 246 may have a refractive index that is the same as a refractive index of the first dielectric layer 242. In some non-limiting embodiments, the third dielectric layer 246 may have a refractive index of greater than 1.75, for example greater than 1.9, for example greater than 2.0 for light with a wavelength of 900 nm. For example, the third dielectric layer 246 may have a refractive index between 1.9 and 2.1, or about 2.0 for light with a wavelength of 900 nm.

In some non-limiting embodiments, a fourth dielectric layer 248 may be positioned over at least a portion of the third dielectric layer 246. The fourth dielectric layer 248 may be in direct contact with the third dielectric layer 246. The fourth dielectric layer 248 may be the same as the fourth dielectric layer 48 previously described. The fourth dielectric layer 248 may include the same or different material as the second dielectric layer 244. In some non-limiting embodiments, the fourth dielectric layer 248 may comprise silicon. For example, the fourth dielectric layer 248 may include silicon, silicon and aluminum, alloys comprising silicon, or a combination thereof. For example, the fourth dielectric layer 248 may include silicon oxide, silicon aluminum oxide, or a combination thereof.

The fourth dielectric layer 248 may have a thickness of at least 100 nm, or at least 110 nm, or at least 120 nm, or at least 130 nm, or at least 135 nm. The fourth dielectric layer 248 may have a thickness of up to 200 nm, or up to 195 nm, or up to 190 nm, or up to 185 nm, or up to 180 nm. The fourth dielectric layer 248 may have a thickness in the range of 100 nm to 200 nm, or in the range of 110 nm to 195 nm, or in the range of 120 nm to 190 nm, or in the range of 130 nm to 185 nm, or in the range of 130 nm to 180 nm, or in the range of 135 nm to 180 nm.

The fourth dielectric layer 248 may have a refractive index that is lower than a refractive index of the first dielectric layer 242 and the third dielectric layer 246. The fourth dielectric layer 248 may have a refractive index that is the same as a refractive index of the second dielectric layer 244. In some non-limiting embodiments, the fourth dielectric layer 248 may have a refractive index of less than 1.75, for example less than 1.7, for example less than 1.6 for light with a wavelength of 900 nm. For example, the fourth dielectric layer 248 may have a refractive index between 1.4 and 1.6, or about 1.5, for light with a wavelength of 900 nm.

The dielectric layers 242, 244, 246, 248 can be deposited by any conventional method, such as but not limited to conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as but not limited to sol-gel deposition. In one non-limiting embodiment, the dielectric layers 242, 244, 246, 248 can be deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750. In the MSVD method, an oxide of a metal or metal alloy can be deposited by sputtering a metal or metal alloy containing cathode in an oxygen containing atmosphere to deposit a metal oxide or metal alloy oxide film on the surface of the substrate. In some non-limiting embodiments, the dielectric layers 242, 244, 246, 248 is deposited over all or substantially all of the surface, i.e., is not deposited to form discrete coated areas. The dielectric layers 242, 244, 246, 248 can be deposited over a flat substrate and then the substrate can be bent or shaped in any conventional manner, such as by heating. Alternatively, the dielectric layers 242, 244, 246, 248 can be deposited over a curved surface, i.e., a substrate that has already been bent or shaped.

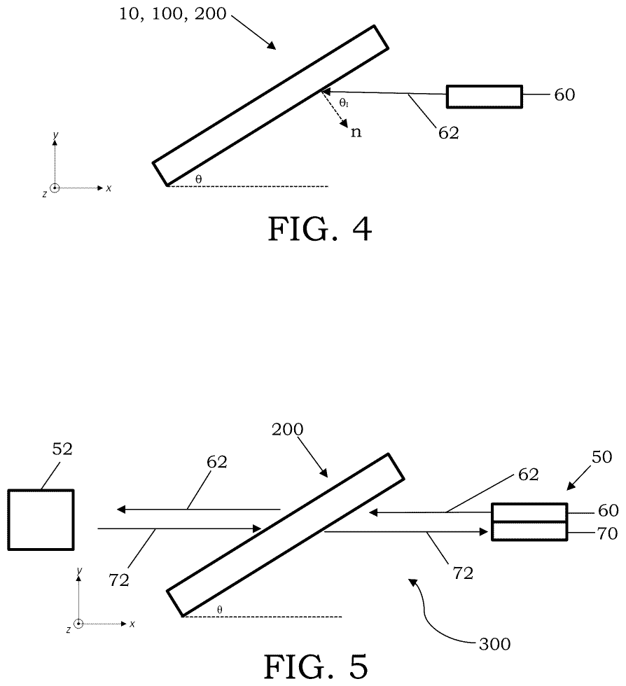

Referring to FIG. 4, the coated article 10, the monolithic transparency 100, or the windshield 200 may be placed (e.g., installed) at an angle of θ relative to the x-axis. The angle θ of the coated article 10, the monolithic transparency 100, or the windshield 200 may be between greater than 0° to 90°, relative to the x-axis. For example, the angle θ of the coated article 10, the monolithic transparency 100, or the windshield 200 may be 10°, or 20°, or 30°, or 40°, or 50°, or 60°, or 70°, or 80°, or 90°, relative to the x-axis. The coated article 10, the monolithic transparency 100, or the windshield 200 may be contacted with light 62 from a light source 60. The angle of incidence Or, relative to the normal n of the coated article 10, the monolithic transparency 100, or the windshield 200, in which the light 62 contacts the coated article 10, the monolithic transparency 100, or the windshield 200 will be dependent on the angle in which the coated article 10, the monolithic transparency 100, or the windshield 200 is placed. For example, if the coated article 10, the monolithic transparency 100, or the windshield 200 is placed at an angle of 30°, then the angle of incidence would be about 60°, relative to the normal n of the coated article 10, the monolithic transparency 100, or the windshield 200.

The light source 60 may be configured to contact the coated article 10, the monolithic transparency 100, or the windshield 200 with light 62 in the infrared spectrum (i.e., infrared radiation). For example, the light 62 from the light source 60 may have a wavelength in the range of 800 nm to 1,050 nm, or in the range of 825 nm to 1,000 nm, or in the range of 850 to 950 nm, or in the range of 875 nm to 925 nm. For example, the light 62 from the light source 60 may have a wavelength of about 900 nm.

The coated article 10, the monolithic transparency 100, or the windshield 200, when contacted with light 62 from the light source 60, may transmit more light 62 compared to the same coated article 10, monolithic transparency 100, or windshield 200 except without the first dielectric layer 42, 142, 242, second dielectric layer 42, 142, 244, third dielectric layer 46, 146, 246, and fourth dielectric layer 48, 148, 248. For example, the coated article 10, the monolithic transparency 100, or the windshield 200, when contacted with light 62 from the light source 60, may transmit at least 1%, or at least 2%, or at least 3% more light 62 compared to the same coated article 10, monolithic transparency 100, or windshield 200 except without the first dielectric layer 42, 142, 242, second dielectric layer 44, 144, 244, third dielectric layer 46, 146, 246, and fourth dielectric layer 48, 148, 248. The coated article 10, the monolithic transparency 100, or the windshield 200, when contacted with light 62 from the light source 60, may transmit at least 75%, or at least 80%, or at least 85%, or at least 90%, or at least 95% of the light 62 from the light source 60. The light 62 from the light source 60 may have a wavelength in the range of 800 nm to 1,050 nm, or in the range of 825 nm to 1,000 nm, or in the range of 850 to 950 nm, or in the range of 875 nm to 925 nm. For example, the light 62 from the light source 60 may have a wavelength of about 900 nm.

Referring to FIG. 5, a LiDAR system 300 may include the previously described windshield 200. LiDAR is a technique where near-infrared light (e.g., 905 nm wavelength) is emitted by a light source 60, reflected from an object 52, and the reflected light 72 is detected by a light detector 70. The elapsed time for the light to make the round trip from the light source 60 to the light detector 70 allows the distance to the object 52 to be calculated. When many light beams 62 are employed in rapid succession, this enables a spatial “map” of the surrounds to be generated. LiDAR's ability to rapidly map surrounds in real-time makes it an enabling technology for autonomous vehicles. In order to maximize the signal-to-noise ratio of the LiDAR system 300, it is necessary to maximize the intensity of the light 62 incident on the object 52 from which it is reflected, and as well as to maximize the reflected light 72 reaching the light detector 70. Reflectance loss occurs at the interface between the interior passenger cabin and the inboard-facing surface of the windshield 200, as well as at the interface between the external environment and the outboard-facing surface of the windshield 200. These reflectance losses can be reduced by employing the first dielectric layer 242, the second dielectric layer 244, the third dielectric layer 246, and the fourth dielectric layer 248 on a surface of the windshield 200.

A LIDAR sensor 50 may be positioned behind the windshield 200. The LiDAR sensor 50 may include the previously described light source 60 and a light detector 70. The LiDAR sensor 50 may be configured to contact the windshield 200 with light 62 from the light source 60.

The light 62 from the light source 60 of the LiDAR sensor 50 may travel through (i.e., transmitted) the windshield 200 and out the other side of the windshield 200. The light 62 that is transmitted through the windshield 200 may contact an object 52 that is positioned on the opposite of the windshield 200 from the LiDAR sensor 50. The object 52, when contacted with the light 62, may reflect the light 62 back towards the windshield 200 as reflected light 72. The reflected light 72 may then travel through (i.e., transmitted) the windshield 200 and back towards the LiDAR sensor 50, where the reflected light 72 may be detected by the light detector 70.

The LiDAR system 300 shown in FIG. 5 may be implemented in various applications. For example, the LiDAR system 300 of FIG. 5 may be implemented in an autonomous vehicle. As used herein, a “vehicle” may refer to any mode of transportation, including, but not limited to, passenger vehicles, automobiles, semi-trucks, motorcycles, bicycles, buses, trains, subways, aircrafts, airplanes, helicopters, spacecrafts, watercrafts, ships, boats, underwater vehicles (e.g., submarines), golf carts, forklifts, and/or the like.

The windshield 200 may form the windshield of an autonomous vehicle and at least one LiDAR sensor 50 may be positioned proximate to the fourth surface 214 of the windshield 200 within the cabin of the autonomous vehicle. The LiDAR system 300 may be implemented with the autonomous vehicle in order to detect object(s) 52 that surround the autonomous vehicle and build a spatial map of the surroundings. Non-limiting examples of object(s) 52 that the LiDAR system 300 may detect include other vehicles, pedestrians, obstacles, barriers, roadway hazards, and/or the like. The LiDAR system 300 of FIG. 5 may be implemented with the autonomous vehicle in order to identify where an object 52 is located such that the autonomous vehicle may maneuver away from the object 52.

The following Examples illustrate various embodiments of the invention. However, it is to be understood that the invention is not limited to these specific embodiments.

### EXAMPLES

A four-layer antireflective (AR) coating was deposited onto five 39 inch×51 inch STARPHIRE® glass substrates, each having a nominal thickness of 2.1 mm. The four layer structure included the following layer structure and nominal/target thicknesses: (1—closest to the substrate) Zn52-Sn48 oxide (i.e., zinc stannate) at 22 nm; (2) Si85-Al15 oxide at 23 nm; (3) Zn52-Sn48 oxide (i.e., zinc stannate) at 164 nm; (4—furthest from the substrate) Si85-Al15 oxide at 141 nm. The coatings were deposited using an MSVD Pilot Coater using a MSVD process in five consecutive coater loads.

Prior to depositing the coating on the 39 inch×51 inch substrates, successive “color shot” samples were made where coatings were deposited onto 4 inch×4 inch STARPHIRE® glass substrates having a thickness of 2.1 mm. After each color shot, the coated specimen was heat-treated in a Thermolyne box furnace to simulate a thermal bending/tempering process used to fabricate automotive windshields. The film-side reflectance (Rf) and glass-side reflectance (Rg) at near-nominal (8°) incidence, and the transmittance (T) at normal incidence, of each heat-treated specimen was measured using a Hunter PRO spectrophotometer. The measured reflectance (Rf and Rg) and transmittance spectra were then fit to an optical model, using MSVD Layer Control software. The MSVD Layer Control software then made recommendations regarding which of the four coating layers needed to be adjusted in thickness, and by what magnitude, in order to get the coating on-target.

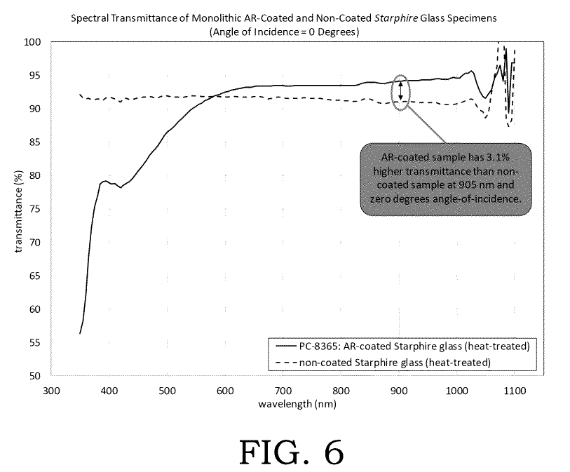

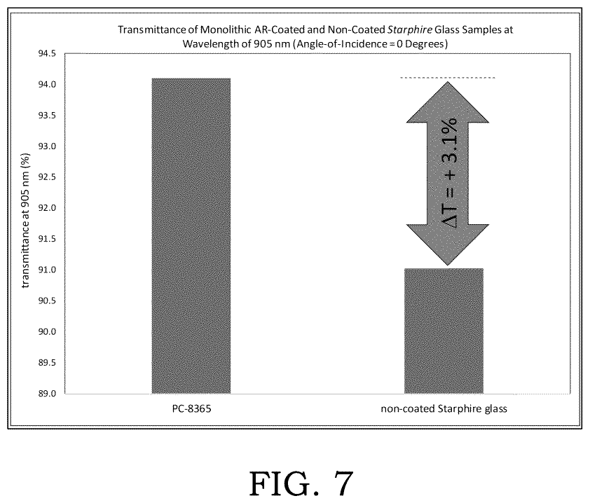

The spectral transmittance of a monolithic uncoated specimen of 2.1 mm STARPHIRE® glass, and a monolithic antireflective-coated STARPHIRE® glass employing a substrate from the same lot, at an angle of incidence of zero degrees (0°), is plotted in FIG. 6. As shown in FIG. 6, the antireflective-coated STARPHIRE® glass exhibits a higher transmittance than the uncoated STARPHIRE® glass over nearly all wavelengths greater than about 580 nm. In particular, the antireflective-coated STARPHIRE® glass exhibits a 3.1% higher transmittance than the uncoated STARPHIRE® glass at a wavelength of 905 nm (FIG. 7).

In Table 1 below, the transmittance (non-polarized light) of monolithic antireflective-coated STARPHIRE® glass and a non-coated STARPHIRE® glass at 905 nm as predicted by optical models at two angles of incidence: (1) 0 degrees, and (2) 60 degrees, is provided. As shown in Table 1, the model predicts that the anti-reflective coated STARPHIRE® glass will have a 3.2% higher transmittance compared to the non-coated STARPHIRE® glass at 905 nm and 0° angle of incidence, which is consistent with the measured 3.1% higher transmittance observed under these conditions as shown in FIG. 6. Table 1 further shows that the optical model also predicts that the monolithic antireflective-coated STARPHIRE® glass will have a 3.5% higher transmittance than the monolithic non-coated STARPHIRE® glass at 905 nm and an angle of incidence of 60°, which is the relevant angle of incidence for a windshield installed in a vehicle.

TABLE 1
Transmittance (non-polarized light) of Monolithic
Antireflective-coated STARPHIRE ® glass vs.
Monolithic Non-coated STARPHIRE ®
glass as predicted by Optical Model

| Angle of | Non- | antireflective- | |
|---|---|---|---|
| Incidence | coated T at | coated T at | ΔT at |
| (°) | 905 nm | 905 nm | 905 nm |
| 0 | 90.7% | 93.9% | +3.2% |
| 60 | 83.1% | 86.6% | +3.5% |

Table 2 below shows the corresponding transmittance of laminate configurations, predicted by optical models, including: (1) either an antireflective-coated or non-coated STARPHIRE® glass inner ply, (2) a 0.7 mm polyvinyl butyral (PVB) interlayer, and (3) a non-coated STARPHIRE® glass outer ply at the same wavelength and angles of incidence as reported in Table 1. The difference in transmittance between the laminate configuration employing the antireflective-coated STARPHIRE® glass ply and the non-coated STARPHIRE® glass ply is the same as that shown in Table 1. Table 2 is included to show the absolute transmittance of the two different laminate configurations as predicted by the optical model.

TABLE 2
Transmittance (non-polarized light) of Antireflective-
coated Windshield laminate vs. Non-coated
Windshield Laminate as Predicted by Optical Model

| Angle of | Non- | antireflective- | |
|---|---|---|---|
| Incidence | coated T at | coated T | ΔT |
| (°) | 905 nm | at 905 nm | at 905 nm |
| 0 | 88.7% | 91.9% | +3.2% |
| 60 | 80.8% | 84.3% | +3.5% |

What is claimed is:

1. A coated article, comprising:
a substrate;
a first dielectric layer comprising a metal oxide, metal alloy oxide, metal nitride, metal alloy nitride, or a combination thereof and having a thickness of up to 40 nm over at least a portion of the substrate;
a second dielectric layer having a thickness of up to 40 nm over at least a portion of the first dielectric layer;
a third dielectric layer comprising a metal oxide, metal alloy oxide, metal nitride, metal alloy nitride, or a combination thereof and having a thickness of at least 130 nm over at least a portion of the second dielectric layer; and
a fourth dielectric layer having a thickness of at least 130 nm over at least a portion of the third dielectric layer;
wherein the coated article, when contacted at 60° with light having a wavelength between 800 nm to 1,050 nm from a light source, transmits at least 75% of the light.

2. The coated article of claim 1, wherein the substrate comprises glass having a total iron content of at most 0.02 wt %.

3. The coated article of claim 1, wherein the first dielectric layer and the third dielectric layer comprise the same material.

4. The coated article of claim 1, wherein the first dielectric layer and the third dielectric layer each independently comprise zinc stannate, zinc oxide, tin oxide, silicon nitride, or a combination thereof.

5. The coated article of claim 1, wherein the second dielectric layer and the fourth dielectric layer comprise the same material.

6. The coated article of claim 1, wherein the second dielectric layer and the fourth dielectric layer each independently comprise silicon, silicon and aluminum, alloys comprising silicon, or a combination thereof.

7. The coated article of claim 6, wherein the second dielectric layer and the fourth dielectric layer each independently comprise an oxide, a nitride, an oxynitride, or a combination thereof.

8. The coated article of claim 7, wherein the second dielectric layer and the fourth dielectric layer each independently comprise silicon oxide, silicon aluminum oxide, or a combination thereof.

9. The coated article of claim 1, wherein the first dielectric layer and the second dielectric layer have a thickness in a range of from 10 nm to 40 nm.

10. The coated article of claim 9, wherein the first dielectric layer and the second dielectric layer have a thickness in a range of from 20 nm to 35 nm.

11. The coated article of claim 1, wherein the third dielectric layer and the fourth dielectric layer have a thickness in a range of from 130 nm to 180 nm.

12. The coated article of claim 11, wherein the third dielectric layer has a thickness in a range of from 145 nm to 170 nm, and the fourth dielectric layer has a thickness in a range of from 135 nm to 180 nm.

13. The coated article of claim 1, wherein the first dielectric layer and the second dielectric layer are in direct contact with one another, and wherein the third dielectric layer and the fourth dielectric layer are in direct contact with one another.

14. The coated article of claim 13, wherein the second dielectric layer and the third dielectric layer are in direct contact with one another.

15. The coated article of claim 1, wherein the light has a wavelength of about 900 nm.

16. The coated article of claim 1, wherein the coated article transmits at least 80% of the light.

17. The coated article of claim 1, wherein the coated article transmits at least 85% of the light.

18. The coated article of claim 1, wherein the coated article consists of:
the substrate;
the first dielectric layer;
the second dielectric layer;
the third dielectric layer; and
the fourth dielectric layer.

19. A LiDAR system, comprising:
a windshield, comprising:
a first ply comprising a first surface and a second surface opposite the first surface;
a second ply comprising a third surface adjacent the second surface and a fourth surface opposite the third surface;
a first dielectric layer comprising a metal oxide, metal alloy oxide, metal nitride, metal alloy nitride, or a combination thereof and having a thickness of up to 40 nm over at least a portion of the first surface or the fourth surface;
a second dielectric layer having a thickness of up to 40 nm over at least a portion of the first dielectric layer;
a third dielectric layer comprising a metal oxide, metal alloy oxide, metal nitride, metal alloy nitride, or a combination thereof and having a thickness of at least 130 nm over at least a portion of the second dielectric layer; and
a fourth dielectric layer having a thickness of at least 130 nm over at least a portion of the third dielectric layer;
wherein the windshield, when contacted at 60° with light having a wavelength between 800 nm to 1,050 nm from a light source, transmits at least 75% of the light, and
at least one LiDAR sensor positioned proximate to the fourth surface.

20. An autonomous vehicle, comprising:
a LiDAR system, the LiDAR system comprising:
a windshield, comprising:
a first ply comprising a first surface and a second surface opposite the first surface;
a second ply comprising a third surface adjacent the second surface and a fourth surface opposite the third surface;
a first dielectric layer comprising a metal oxide, metal alloy oxide, metal nitride, metal alloy nitride, or a combination thereof and having a thickness of up to 40 nm over at least a portion of the first surface or the fourth surface;
a second dielectric layer having a thickness of up to 40 nm over at least a portion of the first dielectric layer;
a third dielectric layer comprising a metal oxide, metal alloy oxide, metal nitride, metal alloy nitride, or a combination thereof and having a thickness of at least 130 nm over at least a portion of the second dielectric layer; and
a fourth dielectric layer having a thickness of at least 130 nm over at least a portion of the third dielectric layer;
wherein the windshield, when contacted at 60° with light having a wavelength between 800 nm to 1,050 nm from a light source, transmits at least 75% of the light, and
at least one LiDAR sensor positioned proximate to the fourth surface.
